(19) United States
(12) Patent Application Publication
(10) Pub. No.: US 2009/0309257 A1
(43) Pub. Date: Dec. 17, 2009

(54) MASTER FOR MANUFACTURING MOLD, MOLD FOR MANUFACTURING DISPLAY DEVICE AND MANUFACTURING METHODS THEREOF

(76) Inventors: Dae-Jin Park, Incheon (KR); Jung-Mok Bae, Seoul (KR); Jae-Hyuk Chang, Seongnam-si (KR); Ju-Han Bae, Suwon-si (KR)

Correspondence Address: Haynes and Boone, LLP;IP Section, 2323 Victory Avenue, SUITE 700, Dallas, TX, 75219, US

(21) Appl. No.: 12/273,467

(22) Filed: Nov. 18, 2008

(30) Foreign Application Priority Data
Jun. 11, 2008 (KR) 10-2008-0054543

(51) Int. Cl. B29C 33/40

(52) U.S. Cl. 264/220; 425/195; 425/177

(57) ABSTRACT

The present invention relates to a master for manufacturing a mold, a mold for manufacturing a display device, a manufacturing method of the mold using the master, and a manufacturing method of the display device using the mold in an imprinting process. A master for manufacturing a mold according to one or more embodiments of the present invention comprises a substrate, and a master pattern formed on the substrate and comprising an embossed portion, wherein the embossed portion comprises levees formed on both edges thereof. A side surface of the embossed portion may form an angle of about 60 to 90 degrees with a surface of the substrate. When the mold manufactured using the master is used in the imprinting process to manufacture the display device, air bubbles are kept away from the side surface of a resin pattern. Accordingly, defects of the wire pattern of the display device may be prevented.

### CROSS-REFERENCE TO RELATED APPLICATION

This application claims priority to and the benefit of Korean Patent Application No. 10-2008-0054543 filed in the Korean Intellectual Property Office on Jun. 11, 2008, the entire contents of which are incorporated herein by reference.

### BACKGROUND

(a) Technical Field

One or more embodiments of the present invention generally relate to a master for manufacturing a mold, a mold for manufacturing a display device, a manufacturing method of the mold using the master, and a manufacturing method of the display device using the mold.

(b) Description of the Related Art

A display device such as a liquid crystal display (LCD) includes a display panel that is provided with a plurality of wire patterns such as various signal lines and electrodes. These patterns may be formed by depositing metal layers on a substrate, coating a photosensitive film on the metal layers, and executing a photolithography process on the photosensitive film and metal layers.

The conventional photolithography process has proven adequate in providing for the wire patterns of the display panel. However, as the requirements for large screen and high resolution display devices are increasing, the cost of the photolithography process has also increased. Therefore, an imprinting process has been developed to reduce the manufacturing cost of the display panel. In the imprinting process, a resin for forming a pattern is coated on a display panel and is pressed by a mold to thereby form a desired resin pattern, and then a lithography process is executed using the resin pattern as an etching mask. The imprinting process may form more minute and more variety of patterns compared with those formed by the photolithography process, and may also form complex patterns such as three-dimensional patterns. Also, the productivity of the display device may be improved and the manufacturing cost may be reduced.

However, air bubbles may be generated when the mold and the display panel coated with the resin for imprinting are combined in an imprinting process. The resulting air bubbles may affect the resin pattern, causing defects of the wire. Accordingly, there is a need in the art for an imprinting process that may prevent defects of the wire caused by the air bubbles.

The above information disclosed in this Background section is only for enhancing an understanding of the background of the invention. Therefore it may contain information that does not form prior art that would be known in this country to a person of ordinary skill in the art.

### SUMMARY

Accordingly, one or more embodiments of the present invention may provide a master for the mold, a mold, a method for manufacturing the master, a method for manufacturing the mold from the mater, and a method for manufacturing a display device from the mold in an imprinting process to prevent defects of the wire caused by the air bubbles.

A master for manufacturing a mold according to one or more embodiments of the present invention includes a substrate, and a master pattern formed on the substrate and including an embossed portion, wherein the embossed portion includes levees formed on both edges thereof.

In accordance with an embodiment of the present invention, a side surface of the embossed portion may form an angle of about 60 to 90 degrees with a surface of the substrate.

In accordance with an embodiment of the present invention, a width of the levees may be in the range of about 0.3 μm to about 1.5 μm.

In accordance with an embodiment of the present invention, a height of the levees may be in the range of about 0.3 μm to about 1.5 μm.

In accordance with an embodiment of the present invention, the master pattern may be formed through a laser direct writing method

A mold for manufacturing a display device according to one or more embodiments of the present invention includes a substrate, and a mold pattern formed on the substrate and including a depressed portion, wherein the depressed portion includes furrows formed on both edges thereof.

In accordance with an embodiment of the present invention, a side surface of the depressed portion may form an angle of about 60 to 90 degrees with a surface of the substrate.

In accordance with an embodiment of the present invention, a width of the furrows may be in the range of about 0.3 μm to about 1.5 μm.

In accordance with an embodiment of the present invention, a depth of the furrows may be in the range of about 0.3 μm to about 1.5 μm.

In accordance with an embodiment of the present invention, the mold pattern may include a polymer such as an elastomer.

A manufacturing method for a mold for a display device according to one or more embodiments of the present invention includes providing a master substrate, forming a resist layer on the master substrate, etching the resist layer to form a master pattern including an embossed portion, and pressing a mold substrate deposited with a polymer on the master pattern to form a mold pattern including a depressed portion, wherein the embossed portion includes levees formed on both edges thereof, and the depressed portion includes furrows formed on both edges thereof.

In accordance with an embodiment of the present invention, a side surface of the embossed portion may form an angle of about 60 to 90 degrees with a surface of the master substrate.

In accordance with an embodiment of the present invention, the embossed portion and the levee may be formed by using a laser direct writing method.

A manufacturing method for a display device according to one or more embodiments of the present invention includes forming a wiring layer on an insulation substrate, forming a resin layer on the wiring layer, aligning and imprinting a mold substrate on which a mold pattern including a depressed portion is formed on the resin layer to form a resin pattern, and etching the wiring layer by using the resin pattern as a mask, wherein the depressed portion includes furrows formed on both edges thereof.

In accordance with an embodiment of the present invention, a side surface of the depressed portion may form an angle of about 60 to 90 degrees with a surface of the mold substrate.

In accordance with an embodiment of the present invention, the forming of the resin pattern may be executed in a vacuum state.

In accordance with an embodiment of the present invention, the forming of the resin pattern may be performed using a press roller.

### BRIEF DESCRIPTION OF THE DRAWINGS

FIG. 1 is a top plan view showing a portion of a wire according to one or more embodiments of the present invention.

FIG. 2 is a cross-sectional view of a master and a mold for an imprinting process according to one or more embodiments of the present invention.

FIG. 3 is a cross-sectional view of the mold, resin and a wiring layer of a display device for an imprinting process according to one or more embodiments of the present invention showing a portion of a process for forming the wire shown in FIG. 1.

FIG. 4 to FIG. 10 are cross-sectional views sequentially showing intermediate steps of a method for forming a wire pattern according to one or more embodiments of the present invention.

### DESCRIPTION OF REFERENCE NUMERALS INDICATING PRIMARY ELEMENTS IN THE DRAWINGS

| | | | |
|---|---|---|---|
| 2: | air bubble | 20: | press roller |
| 50: | master | 51: | master substrate |
| 52: | master pattern | 53: | embossed portion |
| 60: | mold | 61: | mold substrate |
| 62: | mold pattern | 63: | depressed portion |
| 70: | resin layer | 71: | resin pattern |
| 110: | insulating substrate | 120: | wiring layer |
| 121: | wire | | |

### DETAILED DESCRIPTION OF THE EMBODIMENTS

Embodiments of the present invention will be described more fully hereinafter with reference to the accompanying drawings, in which one or more embodiments of the invention are shown. However, the present invention should not be construed as being limited to the embodiments set forth herein. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification and the drawings. It will be understood that when an element such as a layer, film, region, or substrate is referred to as being “on” another element, it may be directly on the other element or intervening elements may also be present. In contrast, when an element is referred to as being “directly on” another element, there are no intervening elements present.

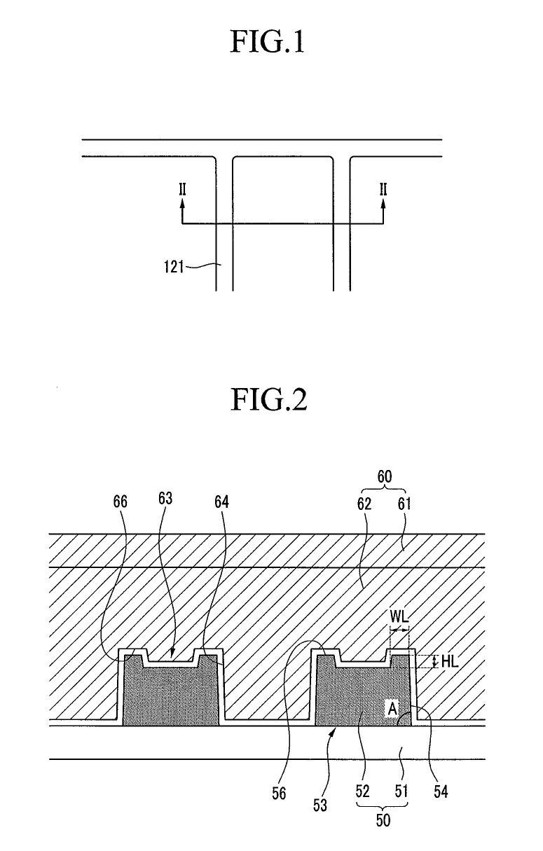

First, a mold for an imprinting process and a master for forming the mold according to one or more embodiments of the present invention will be described in detail with reference to FIG. 1 to FIG. 3.

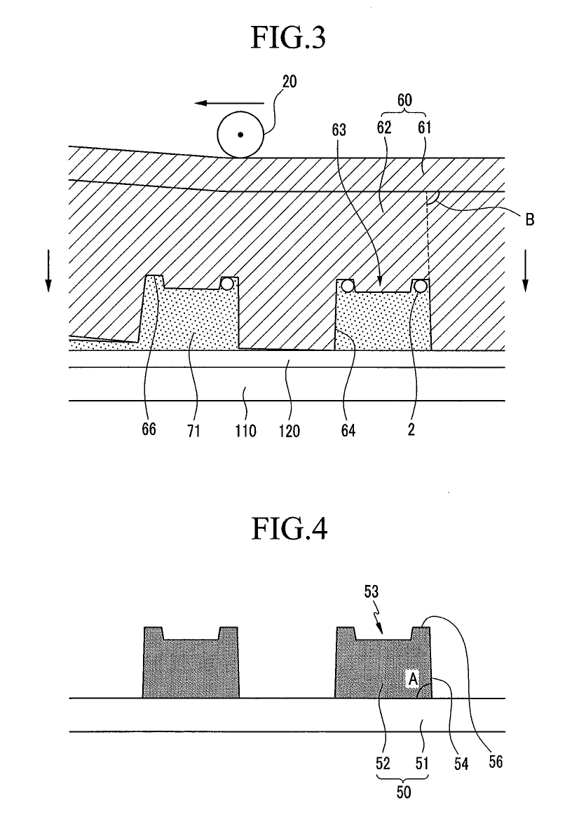

FIG. 1 is a top plan view showing a portion of a wire according to one or more embodiments of the present invention; FIG. 2 is a cross-sectional view of a master and a mold for an imprinting process according to one or more embodiments of the present invention; and FIG. 3 is a cross-sectional view of the mold, resin and a wiring layer of a display device for an imprinting process according to one or more embodiments of the present invention showing a portion of a process for forming the wire shown in FIG. 1.

Referring to FIG. 1, a wire 121 according to one or more embodiments of the present invention includes a transverse portion and a pair of longitudinal portions extending downward from the transverse portion. FIG. 1 shows one example of the shape of the wire, and the shape of the wire may be variously modified.

Referring to FIG. 2, a master 50 according to one or more embodiments of the present invention includes a master substrate 51 and a master pattern 52 formed on the master substrate 51, wherein the master pattern 52 includes an embossed portion 53.

As shown in FIG. 2, the embossed portion 53 of the master pattern 52 includes a pair of edge levees 56 formed along both edges thereof. The width WL and the height HL of the edge levees 56 may be more than about 0.3 μm and less than about 1.5 μm. However, the width WL and the height HL of the edge levees 56 may also be less than or more than these values.

A side surface 54 of the embossed portion 53 of the master pattern 52 forms an angle A in the range of about 60 to 90 degrees with a surface of the master substrate 51, and more particularly from about 80 to 90 degrees. As will be shown in FIG. 3, when the angle A is less than 60 degrees, it may be difficult for the air bubbles to climb up a resin pattern of a display device when a mold manufactured from the master pattern with such an angle A is pressed against the resin layer in an imprinting process. Failure of the air bubbles to climb up the resin pattern may cause defects of the wire when the resin pattern is used as an etching mask to form the wire. The master pattern 52 may be etched from a resist layer formed on the master substrate 51.

A mold 60 manufactured by using such a master 50 includes a mold substrate 61 and a mold pattern 62 formed on the mold substrate 61. The mold pattern 62 includes a depressed portion 63 that is formed when the mold is cast from the master pattern 52 with the embossed portion 53.

As shown in FIG. 2, the depressed portion 63 of the mold pattern 62 includes a pair of edge furrows 66 formed along both edges thereof corresponding to the edge levees 56 of the master pattern 52. The width and depth of the edge furrows 66 may be in the range of about 0.3 μm to 1.5 μm, or may be less than or more than these values to correspond with the width WL and the height HL of the edge levees 56. Small air bubbles having a volume between about 0.01 μm³ to about 15 μm³ generated in an imprinting process using the mold 60 may be sufficiently and easily trapped in the furrows 66.

Additionally, as will be shown in FIG. 3, a side surface 64 of the depressed portion 63 of the mold pattern 62 forms an angle B in the range of about 60 to 90 degrees with the surface of the mold substrate 61, and more particularly from about 80 to 90 degrees. The mold pattern 62 may be made of a polymer such as an elastomer.

Next, a process for forming a wire pattern using the mold 60 will be described with reference to FIG. 3.

A wiring layer 120 for forming wire 121 is formed on the insulating substrate 110, and a resin layer for an imprinting process is coated thereon. Next, the mold 60 is aligned on the resin layer and the wiring layer 120 formed on the insulating substrate 110 and is pressed downward to form a resin pattern 71 with a desired shape. Here, a press roller 20 may be used on the outer side of the mold substrate 61 of the mold 60.

As shown in FIG. 3, if the mold 60 manufactured using the master 50 according to one or more embodiments of the present invention is used, even though air bubbles 2 may be generated when the mold 60 is pressed against the resin layer, the air bubbles 2 do not stop in the middle of the side surface 64 of the depressed portion 63 but may come up to the edge furrows 66 since the angle B between the side surface 64 of the depressed portion 63 of the mold pattern 62 and the mold substrate 61 is large. In this way, the air bubble 2 are gathered on the upper surface of the resin pattern 71 such that deformation of the side profile of the resin pattern 71 by the air bubbles 2 may be prevented, thereby forming the desired pattern. Consequently, wire 121 having a desired shape may be formed without defects of the wire after an etching process using the resin pattern 71 as a mask.

In particular, even when the volume of the generated air bubbles 2 is so small (such as less than several tens of μm³) that it is difficult to remove it using other methods, the air bubbles 2 may nevertheless be easily collected at the top surface of the resin pattern 71 using the mold 60 according to one or more embodiments of the present invention. Keeping the air bubbles 2 on the top surface and away from the side surface of the resin pattern 71 prevents defects such as a shorting of the wire when the wiring layer 120 is etched using the resin pattern 71 as an etching mask to form the wire.

Next, a method of forming a wire pattern of a display device by using the master 50 and the mold 60 according to one or more embodiments of the present invention will be described with reference to FIG. 4 to FIG. 10.

FIG. 4 to FIG. 10 are cross-sectional views sequentially showing intermediate steps of a method for forming a wire pattern according to one or more embodiments of the present invention.

First, a resist layer is formed on a master substrate 51 and etched to form a master pattern 52, as shown in FIG. 4. When forming the master pattern 52, a laser direct writing method (DWL) may be used so as to form an angle A having almost a right angle between the side surface 54 of the embossed portion 53 of the master pattern 52 and the surface of the master substrate 51. Other etching methods may also be used instead of the laser direct writing method. The embossed portion 53 of the master pattern 52 also includes the edge levees 56 formed along both edges thereof.

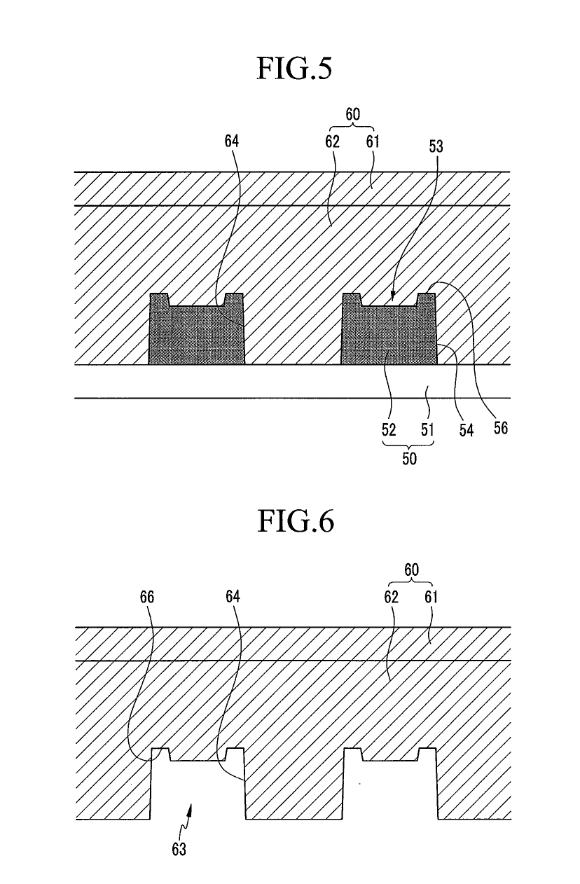

Next, as shown in FIG. 5 and FIG. 6, a mold substrate 61 on which a polymer such as an elastomer is deposited is pressed on the master 50 to cast a mold 60 including a mold pattern 62. The mold pattern 62 includes a depressed portion 63 with edge furrows 66 and the side surface 64.

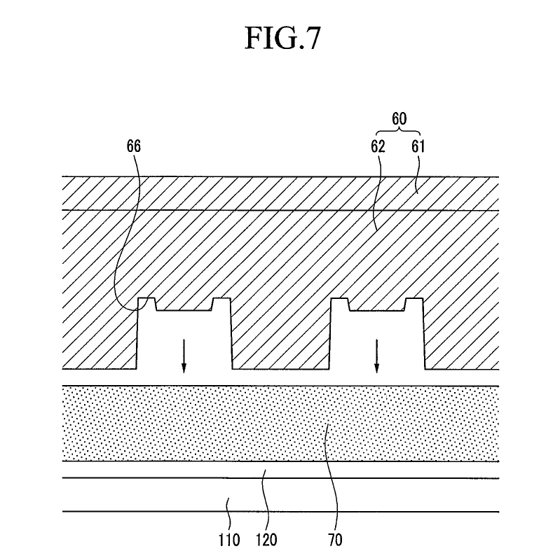

Next, as shown in FIG. 7, a wiring layer 120 made of a metal is deposited on an insulating substrate 110 for a display device by sputtering, and a resin layer 70 for imprinting such as a resist layer is coated on the wiring layer 120.

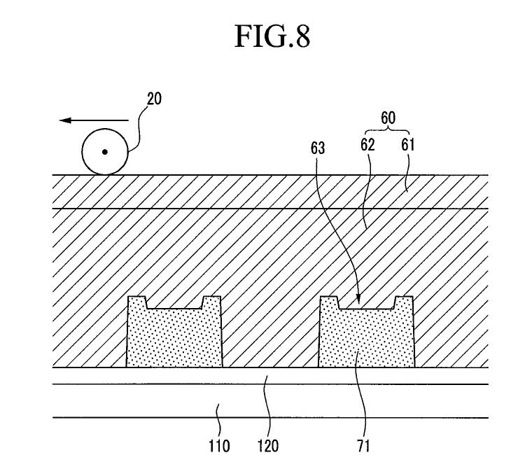

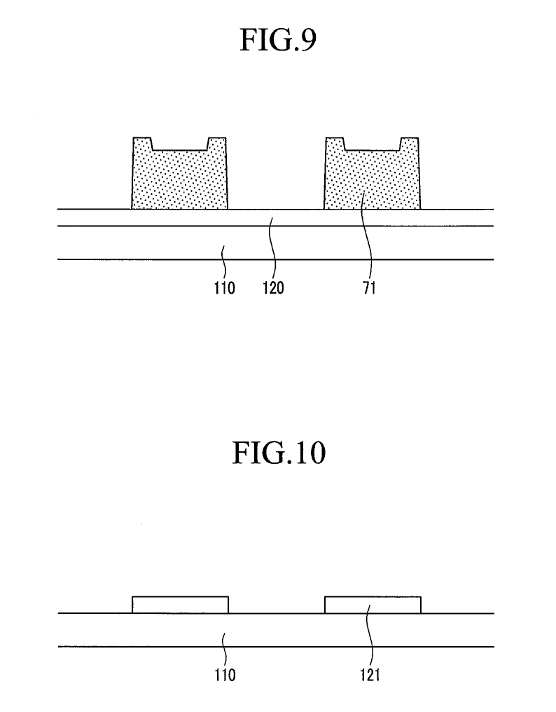

Next, as shown in FIG. 8, the mold 60 is aligned on the resin layer and the wiring layer 120 formed on the insulating substrate 110 and pressed downward using a pressing means such as a press roller 20. Then, the depressed portion 63 of the mold 60 is filled with the resin of the resin layer 70 of FIG. 7, and a resin pattern 71 with a desired shape is formed as shown in FIG. 9. The imprinting process may be executed in a vacuum state.

Next, as shown in FIG. 10, the wiring layer 120 of FIG. 9 is etched using the resin pattern 71 as a mask to form a desired pattern of the wire 121.

Therefore, according to one or more embodiments of the present invention, defects of the wire pattern may be prevented when the wire pattern is formed through an imprinting method.

While this invention has been described in connection with what is presently considered to be practical embodiments, it is to be understood that embodiments of the invention are not limited to the disclosed embodiments. Those skilled in the art will appreciate that various modifications and equivalent arrangements may be made to the disclosed embodiments and still be included within the spirit and scope of the appended claims.

What is claimed is:

1. A master comprising:
a substrate; and
a master pattern disposed on the substrate and comprising an embossed portion,
wherein the embossed portion comprises levees disposed on both edges thereof.

2. The master of claim 1, wherein
a side surface of the embossed portion forms an angle of about 60 to 90 degrees with a surface of the substrate.

3. The master of claim 1, wherein
a width of the levees is in the range of about 0.3 μm to about 1.5 μm.

4. The master of claim 1, wherein
a height of the levee is in the range of about 0.3 μm to about 1.5 μm.

5. The master of claim 1, wherein
the master pattern is formed through a laser direct writing method.

6. A mold comprising:
a substrate; and
a mold pattern disposed on the substrate and comprising a depressed portion,
wherein the depressed portion comprises furrows disposed on both edges thereof.

7. The mold of claim 6, wherein
a side surface of the depressed portion forms an angle of about 60 to 90 degrees with a surface of the substrate.

8. The mold of claim 6, wherein
a width of the furrows is in the range of about 0.3 μm to about 1.5 μm.

9. The mold of claim 6, wherein
a depth of the furrows is in the range of about 0.3 μm to about 1.5 μm.

10. The mold of claim 6, wherein
the mold pattern comprises a polymer comprising an elastomer.

11. A manufacturing method for a mold, comprising:
providing a master substrate;
forming a resist layer on the master substrate;
etching the resist layer to form a master pattern comprising an embossed portion; and
pressing a mold substrate deposited with a polymer on the master pattern to form a mold pattern comprising a depressed portion,
wherein the embossed portion comprises levees formed on both edges thereof, and the depressed portion comprises furrows formed on both edges thereof.

12. The manufacturing method of claim 11, wherein
a side surface of the embossed portion forms an angle of about 60 to 90 degrees with a surface of the master substrate.

13. The manufacturing method of claim 12, wherein
the embossed portion and the levee are formed using a laser direct writing method.

14. A manufacturing method for a display device comprising:
forming a wiring layer on an insulation substrate;
forming a resin layer on the wiring layer;
aligning and imprinting a mold substrate on which a mold pattern comprising a depressed portion is formed on the resin layer to form a resin pattern; and
etching the wiring layer by using the resin pattern as a mask,
wherein the depressed portion comprises furrows formed on both edges thereof.

15. The manufacturing method of claim 14, wherein
a side surface of the depressed portion forms an angle of about 60 to 90 degrees with a surface of the mold substrate.

16. The manufacturing method of claim 14, wherein
the forming of the resin pattern is executed in a vacuum state.

17. The manufacturing method of claim 14, wherein
the forming of the resin pattern is performed using a press roller.
